(19) United States
(12) Patent Application Publication
(10) Pub. No.: US 2016/0265254 A1
(43) Pub. Date: Sep. 15, 2016

(54) SECURITY DEVICE WITH SHIELDED THREADED MEMBER

(71) Applicant: Jeffrey D. Carnevali, Seattle, WA (US)

(72) Inventor: Jeffrey D. Carnevali, Seattle, WA (US)

(21) Appl. No.: 14/643,006

(22) Filed: Mar. 10, 2015

(51) Int. Cl. E05B 73/00

(52) U.S. Cl. CPC E05B 73/00

(57) ABSTRACT

A threaded security device has a knob with a female threaded bore adjacent to one end and extending into an interior of it's body, and a generally cylindrical bore communicating between an end of the threaded bore at the interior of the body and a second opposite end of the body. A threaded security member has a body that is sized to fit completely into the cylindrical bore of the threaded knob, the body of the threaded security member having another female threaded bore adjacent to one end, and a key receiver adjacent to an opposite end from the threaded bore. The key receiver has a key receiver configuration that is selected from a plurality of different key receiver configurations. A key has a key configuration that is selected from a plurality of different key configurations and corresponds to the key receiver configuration of the threaded security member.

### FIELD OF THE INVENTION

The present invention relates to a threaded security device, and in particular to a threaded security device for a knob with a threaded female bore.

### BACKGROUND OF THE INVENTION

Locking security knobs are generally well-known.

One well-known locking-type security knob is the DuraSafe locking knob available from DuraSafe Inc., New Berlin, Wisconsin, United States of America. Such locking-type security knobs are large, cumbersome, expensive to manufacture and are expensive to the purchaser because of an integral lock mechanism at the core.

However, locking-type security knobs are inherently restricted from providing efficient and reliable security without an actual lock mechanism.

### SUMMARY OF THE INVENTION

The present invention is a present invention is a security device for a knob with a threaded female bore that overcomes limitations of the prior art for securing such normally hand-operated threaded knobs.

According to one aspect of the invention, the threaded security device includes a knob formed of a generally rigid body with a female threaded bore positioned adjacent to a first exterior surface of the body and that extends into an interior area of the body. A generally cylindrical bore communicates between the threaded bore at the interior of the body of the knob and a second exterior surface of the body opposite of the first exterior surface.

A threaded security member is formed with a body that is sized to be entirely received into the cylindrical bore of the threaded knob. The body of the threaded security member includes a female threaded bore positioned adjacent to a first end thereof, and a key receiver positioned adjacent to a second end of the body opposite of the threaded bore. The key receiver has a key receiver configuration that is selected from a plurality of different and mutually exclusive key receiver configurations such that a key that matches one such key receiver does not match a different key receiver.

The security device also includes a key formed with a key configuration that is selected from a plurality of different key configurations, such that the selected key configuration corresponds to the key receiver configuration selected for the threaded security member. According to another aspect of the invention, the key of the threaded security device includes either or both of a tool seat positioned on the key body opposite of the key configuration, and a grip mechanism formed on the outside of the key body, each for operating the key with or without a tool.

According to another aspect of the invention, the knob of the threaded security device effectively screens an entire lengthwise extent of the threaded security member. Thus, the entire lengthwise extent of the threaded security member is received into the cylindrical bore of the threaded knob, whereby the knob substantially screens the threaded security member between the first and second ends thereof. For example, the depth of the generally cylindrical bore in the body of the threaded knob is greater than an overall length of the body of the threaded security member.

According to another aspect of the invention, the female threaded bore of the knob portion of the threaded security device is a threaded nut that is seated in the interior of the body of the knob adjacent to the first exterior surface of the body. According to one embodiment, the threaded nut is further spaced away from the first exterior surface of the body of the knob.

According to another aspect of the invention, the knob of the threaded security device is formed with a generally rigid handle extended laterally of the body.

According to another aspect of the invention, the key receiver of the threaded security member is recessed into the second end of the body of the threaded security member, and optionally, the key receiver of the threaded security member is substantially aligned with the threaded bore thereof.

According to another aspect of the invention, the female threaded bore of the threaded security member is a threaded insert that is seated in the interior of the body of the threaded security member. For example, the threaded insert is molded into the body of the threaded security member. According to another aspect of the invention, the threaded insert of the threaded security member is a locknut, also known as a jam nut, lock nut, locking nut, prevailing torque nut, stiff nut or elastic stop nut, or other nut that resists loosening under vibrations and torque. For example, the locknut or other loosening-resistant threaded insert of the threaded security member is a plastic insert locking member that is placed at the end of the nut or other threaded insert and its inner diameter (ID) is slightly smaller than the major diameter of the target screw to which it is mated.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a pictorial view that illustrates the invention embodied by example and without limitation as a security device having a threaded knob and cooperating threaded security member with a key that is matched to threaded security member that overcomes limitations of the prior art for securing normally hand-operated locking-type threaded knobs;

FIG. 2 is a cross-section view that illustrates a threaded security member of the security device of FIG. 1 being assembled into a mutually relatively concentrically rotational slipping relationship with an interlocking interference member between a female threaded bore of the threaded security member and a matchingly threaded rod or bolt, wherein the interlocking interference member of the threaded security member is a locking member such as but not limited to a Nyloc or other locking patch or insert, or is formed as another security nut, such as but not limited to a jam nut or other lock nut, and also illustrates the key that is matched to threaded security member;

FIG. 3 is another cross-section view that illustrates the threaded security member of the security device of FIG. 1 being assembled into a relatively secure relationship with the matchingly threaded rod or bolt for securing the threaded knob relative to the threaded rod or bolt, and also illustrates operation of the key that is matched to threaded security member;

FIG. 4 is another cross-section view that illustrates the threaded security member of the security device of FIG. 1 assembled into a relatively secure relationship with the matchingly threaded rod or bolt for securing the threaded knob relative to the threaded rod or bolt;

FIG. 5 is another cross-section view that illustrates the threaded security member of the security device of FIG. 1 assembled into a relatively secure relationship with the matchingly threaded rod or bolt for securing the threaded knob relative to the threaded rod or bolt, wherein the threaded security member of the security device is positioned for permitting an adjustable relationship between the threaded knob and the threaded rod or bolt for adjusting a device that includes the threaded knob for controlling adjustment;

FIG. 6 is another cross-section view that illustrates the threaded security member of the security device of FIG. 1 assembled into a relatively secure relationship with the matchingly threaded rod or bolt for securing the threaded knob relative to the threaded rod or bolt, wherein the threaded security member of the security device is positioned for permitting an adjustable relationship between the threaded knob and the threaded rod or bolt and illustrating the threaded knob being positioned for permitting adjustment of the device that includes the threaded knob for controlling adjustment;

FIG. 7 illustrates the threaded security member and matching key of the security device of FIG. 1, wherein the threaded security member includes a key receiver having a first key receiver configuration selected from any one of a plurality of different key receiver configurations, and wherein the matching key includes a key projection formed with a first key configuration that is selected from a plurality of different key configurations each corresponding to the key receiver configuration of a different threaded security member, whereby the security device of FIG. 1 is caused to be classified as “tamper-resistant”;

FIG. 8 illustrates the threaded security member and matching key of the security device of FIG. 1, wherein the key receiver is formed having a second key receiver configuration of the plurality of different key receiver configurations that is different from the first key receiver configuration shown in FIG. 7, and wherein the matching key is formed having a second key configuration of the plurality of different key configurations that corresponds to the second key receiver configuration;

FIG. 9 illustrates the threaded security member and matching key of the security device of FIG. 1, wherein the key receiver is formed having a third key receiver configuration of the plurality of different key receiver configurations that is different from the first key receiver configuration shown in FIG. 7, and different from the second key receiver configuration shown in FIG. 8, and wherein the matching key is formed having a third key configuration of the plurality of different key configurations that corresponds to the third key receiver configuration;

FIG. 10 illustrates the threaded security member and matching key of the security device of FIG. 1, wherein the key receiver is formed having a fourth key receiver configuration that is different from all of plurality of different key receiver configurations of the plurality of different key receiver configurations that is different from all of the first key receiver configuration shown in FIG. 7, the second key receiver configuration shown in FIG. 8, and the third key receiver configuration shown in FIG. 9, and wherein the matching key is formed having a fourth key configuration of the plurality of different key configurations that corresponds to the fourth key receiver configuration;

FIG. 11 illustrates the threaded security member and matching key of the security device of FIG. 1, wherein the key receiver is formed having a fifth key receiver configuration that is different from all of plurality of different key receiver configurations of the plurality of different key receiver configurations that is different from all of the first key receiver configuration shown in FIG. 7, the second key receiver configuration shown in FIG. 8, the third key receiver configuration shown in FIG. 9, and the fourth key receiver configuration shown in FIG. 10, and wherein the matching key is formed having a fifth key configuration of the plurality of different key configurations that corresponds to the fifth key receiver configuration;

FIG. 12 illustrates the threaded security member and matching key of the security device of FIG. 1, wherein the key receiver is formed having a sixth key receiver configuration that is different from all of plurality of different key receiver configurations of the plurality of different key receiver configurations that is different from all of the first key receiver configuration shown in FIG. 7, the second key receiver configuration shown in FIG. 8, the third key receiver configuration shown in FIG. 9, the fourth key receiver configuration shown in FIG. 10, and the fifth key receiver configuration shown in FIG. 11, and wherein the matching key is formed having a sixth key configuration of the plurality of different key configurations that corresponds to the sixth key receiver configuration;

FIG. 13 illustrates the threaded security member and matching key of the security device of FIG. 1, wherein the key receiver is formed having a seventh key receiver configuration that is different from all of plurality of different key receiver configurations of the plurality of different key receiver configurations that is different from all of the first key receiver configuration shown in FIG. 7, the second key receiver configuration shown in FIG. 8, the third key receiver configuration shown in FIG. 9, the fourth key receiver configuration shown in FIG. 10, the fifth key receiver configuration shown in FIG. 11, and the sixth key receiver configuration shown in FIG. 12, and wherein the matching key is formed having a seventh key configuration of the plurality of different key configurations that corresponds to the seventh key receiver configuration;

FIG. 14 illustrates the threaded security member and matching key of the security device of FIG. 1, wherein the key receiver is formed having an eighth key receiver configuration that is different from all of plurality of different key receiver configurations of the plurality of different key receiver configurations that is different from all of the first key receiver configuration shown in FIG. 7, the second key receiver configuration shown in FIG. 8, the third key receiver configuration shown in FIG. 9, the fourth key receiver configuration shown in FIG. 10, the fifth key receiver configuration shown in FIG. 11, the sixth key receiver configuration shown in FIG. 12, and the seventh key receiver configuration shown in FIG. 13, and wherein the matching key is formed having a eighth key configuration of the plurality of different key configurations that corresponds to the eighth key receiver configuration; and

FIG. 15 illustrates the threaded security member and matching key of the security device of FIG. 1, wherein the key receiver is formed having a ninth key receiver configuration that is different from all of plurality of different key receiver configurations of the plurality of different key receiver configurations that is different from all of the first key receiver configuration shown in FIG. 7, the second key receiver configuration shown in FIG. 8, the third key receiver configuration shown in FIG. 9, the fourth key receiver configuration shown in FIG. 10, the fifth key receiver configuration shown in FIG. 11, the sixth key receiver configuration shown in FIG. 12, and the seventh key receiver configuration shown in FIG. 13, and the eighth key receiver configuration shown in FIG. 14, and wherein the matching key is formed having a ninth key configuration of the plurality of different key configurations that corresponds to the ninth key receiver configuration.

### DETAILED DESCRIPTION OF PREFERRED EMBODIMENT

As required, a detailed illustrative embodiment of the present protective enclosure is disclosed herein. However, techniques, systems and operating structures in accordance with the present protective enclosure may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present protective enclosure. The following presents a detailed description of an illustrative embodiment (as well as some alternative embodiments) of the present protective enclosure.

In the Figures, like numerals indicate like elements.

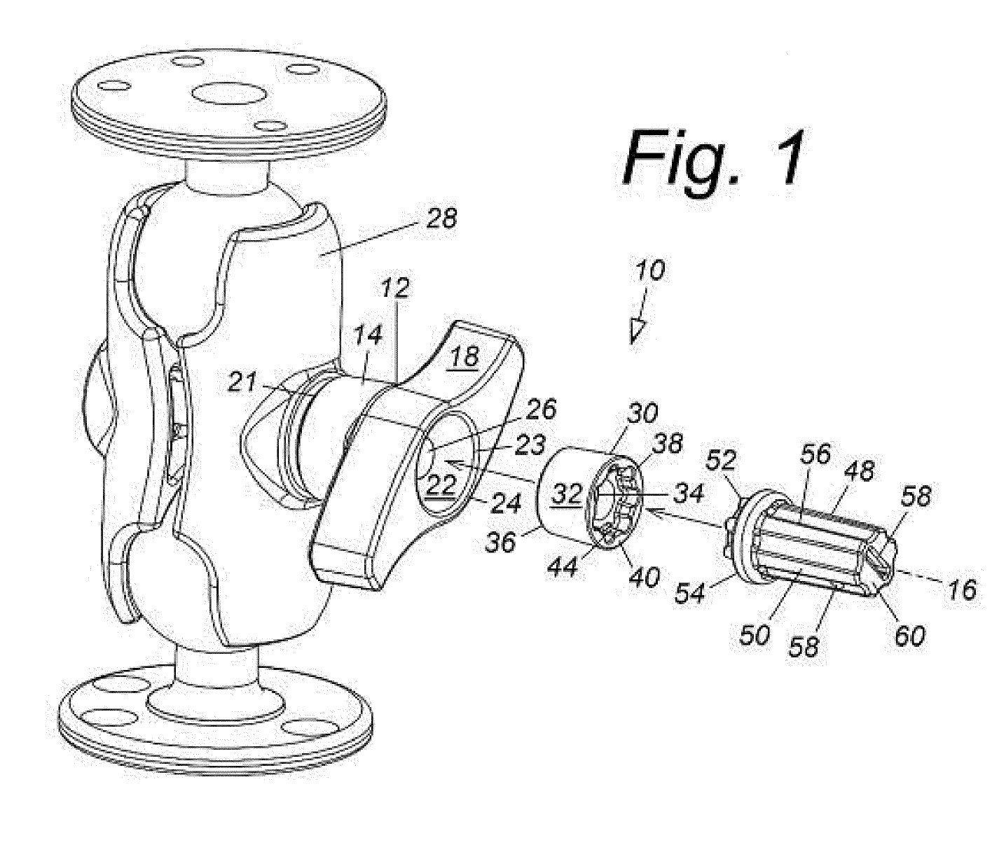

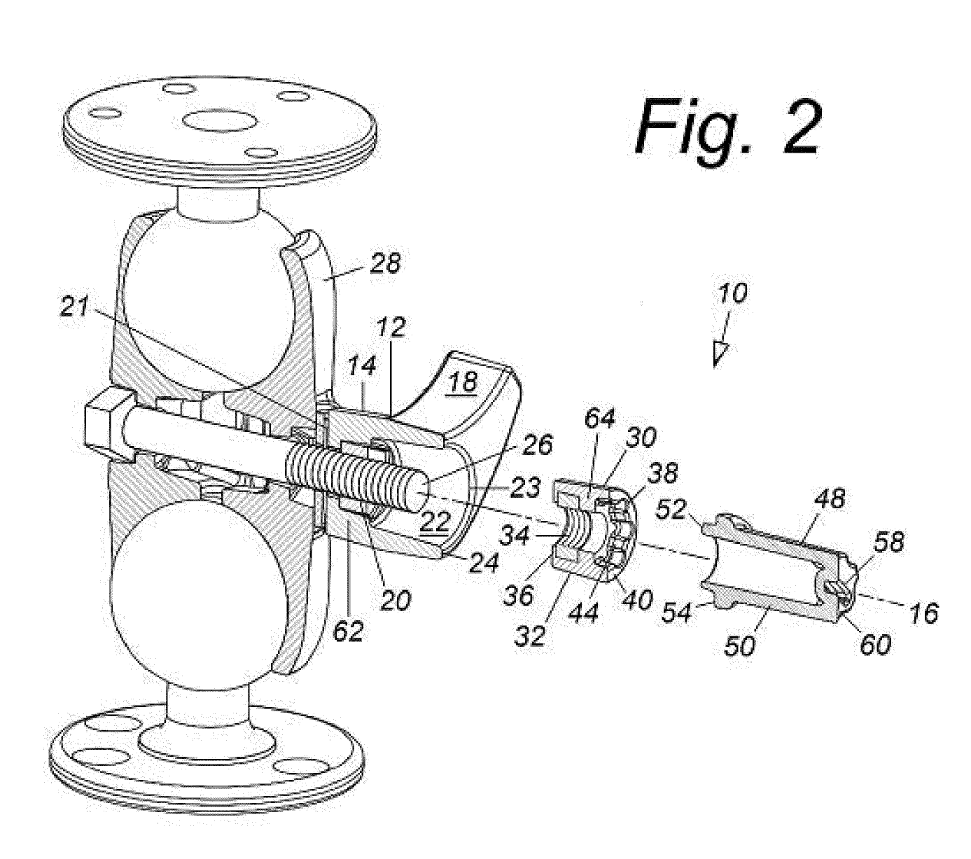

FIG. 1 illustrates one embodiment of the invention for securing normally hand-operated threaded knobs, i.e., threaded knobs tightened and loosened by the user's fingers and hands. FIG. 1 illustrates the invention embodied by example and without limitation as a threaded security device 10 having a threaded knob 12 formed with a generally rigid body 14 that defines a central longitudinal axis 16, and may include a generally rigid handle 18 extended laterally of body 14. Threaded knob 12 includes an internal female threaded bore 20 (FIG. 2) adjacent one exterior end surface 21 of body 14 and aligned along axis 16, and a generally cylindrical bore 22 communicating between threaded bore 20 and an opening 23 in a second exterior end surface 24 of body 14. Threaded bore 20 , for example, has a thread diameter and pitch matched to a threaded male receiver 26, such as a threaded rod or bolt, for clamping or otherwise securing another mechanism, such as but not limited to a ball-and-socket mounts device 28 of the general type disclosed in U.S. Pat. No. 5,845,885, which is incorporated in it's entirety herein by reference. By definition, threaded rod or bolt 26 lies along longitudinal axis 16 of body 14 of threaded knob 12. Cylindrical bore 22 is a clearance bore that is oversized for receiving therethrough threaded male receiver 26. Thus, threaded knob 12 operates to clamp or otherwise secure another mechanism, such as but not limited to a ball-and-socket mounts device 28 of the general type disclosed in U.S. Pat. No. 5,845,885, which is incorporated herein.

Threaded security device 10 includes a threaded security member 30 that is matched to threaded knob 12. Threaded security member 30 is formed of a generally rigid body 32 that is sized to be received into oversized bore 22 of threaded knob 12. Body 32 of threaded security member 30 is formed with a female threaded bore 34 adjacent to it's first end surface 36. Female bore 34 is threaded with the same thread diameter and pitch as threaded bore 20 of threaded knob 12 and matched to threaded rod or bolt 26; any unthreaded portion of bore 34 is a clearance bore that is sized for receiving therethrough threaded male receiver 26. A key receiver 38 adjacent to a second end 40 of body 32 opposite of threaded bore 34, and is generally aligned with threaded bore 34 along axis 16. For example, key receiver 38 is optionally recessed into second end surface 40 of body 32 of threaded security member 30. Key receiver 38 of each different threaded security member 30 for different security devices 10 is formed having a key receiver configuration 44 selected from any one of a plurality of different key receiver configurations 44a, 44b, 44c, etcetera through 44xyz.

Threaded security device 10 includes a key 48 that is matched to threaded security member 30. Key 48 is formed of a generally rigid body 50 having a key projection 51 adjacent to one end 54 thereof. For example, key projection 51 is projected from first end 54 of key body 50. Key projection 51 is formed with a key configuration 52 that is selected from a plurality of different key configurations 52a, 52b, 52c, etcetera through 52xyz each corresponding to key receiver 38 having the selected key receiver configuration 44a, 44b, 44c, etcetera through 44xyz of key receiver 38 of threaded security member 30.

Once installed onto threaded rod or bolt 26, threaded security member 30 cannot be removed, except by application of key 48 having key configuration 52a, 52b, 52c, etcetera and corresponding to the selected key receiver configuration 44a, 44b, 44c, etcetera of key receiver 38 in threaded security member 30. Therefore, threaded knob 12 being positioned between security member 30 and device 28 cannot be removed or even sufficiently loosened to permit loosening or disassembly of device 28. Accordingly, any item secured by security device 10 is secure from unauthorized removal.

Body 50 of key 48 is optionally formed with a grip 56, such as a slotted, knurled, or longitudinal ridges (shown) or other grip formed on an exterior side surface thereof, for turning key 48 by hand. Key 48 may optionally include a tool seat 58, such as a passage for crosswise insertion of a lever, or a slot (shown) for a hex, Philips, or slot head screw driver adjacent to a second end 60 opposite of key projection 51.

FIG. 2 illustrates threaded security device 10 of FIG. 1 in cross-section. Here, threaded knob 12 is illustrated with female threaded bore 20 adjacent to first exterior surface 24 of body 14 and extending into an interior 62 of body 14. Female threaded bore 20 of knob 12 is optionally a thread formed in body 14. Alternatively, female threaded bore 20 of knob 12 is threaded nut or other threaded insert seated in interior 62 of body 14 of knob 12 spaced inwardly away from first exterior surface 21 of body 14. By example and without limitation, threaded insert 20 is further molded into body 14 of knob 12.

Bore 22 communicates between threaded bore 20 at interior 62 of body 14 and second exterior surface 24 of body 14. Bore 22 is larger in lateral extent, i.e., wider, than threaded nut or other threaded insert forming threaded bore 20, whereby bore 22 forms a barrel or bucket in knob 12 having threaded bore 20 in it's bottom and opening onto exterior surface 24 of body 14.

Threaded security member 30 is illustrated here with female threaded bore 34 adjacent to first exterior surface 36 of body 32 and extending into an interior 64 of body 32. Female threaded bore 34 is optionally a threaded nut or other threaded insert seated in interior 64 of body 32 of security member 30 adjacent to first exterior surface 36. Optionally, the threaded nut or other threaded insert forming female threaded bore 34 of threaded security member 30 is further provided as a locknut, also known as a jam nut.

Locknut 34, also known as a jam nut, lock nut, locking nut, prevailing torque nut, stiff nut or elastic stop nut, is a nut that resists loosening under vibrations and torque. Elastic stop nuts and prevailing torque nuts are of the particular type where some portion of the nut deforms elastically to provide a locking action. Locknuts, jam nuts, lock washers, and thread-locking fluid are ways to prevent vibration from loosening a bolted joint. A prevailing torque differentiates a locknut from a free spinning nut based on a value of how much torque is required during installation before clamp loading. For example, on a nylon-insert nut, it is the torque needed to overcome the resistance of the nylon dragging across the mating thread. This torque value is usually not very high relative to final installation torque. Tolerance ranges for torque are specified in some standards such as ISO, DIN, IFI, ASME, SAE, AN-, MS-, NAS- NASM-.

Optionally, locknut 34 is a Nyloc nut, also known as a nylon insert lock nut, polymer insert lock nut or elastic stop nut, which is a kind of nut that includes a nylon collar insert for interlocking with the target male threaded receiver 26. When utilized as locking female threaded bore 34, Nyloc nuts retain their locking ability up to 250° F. (121° C.). Nyloc is a registered trade name of Forest Fasteners, The Marmon Group, a Berkshire Hathaway company, Macomb, Mich. 48042-4007. As best understood, a plastic insert locking member (indicated at 72) is placed at the end of nut or bore 34 and its inner diameter (ID) is slightly smaller than the major diameter of the target screw 26. Plastic insert locking member 72 deforms elastically over the threads of the screw, but threads are not cut into the nylon. Nylon insert locking member 72 locks nut 34 operates in two ways. First, plastic or nylon locking member 72 forces the bottom face of the screw threads against the top face of the threads of nut 34, increasing the friction between the two. Second, insert locking member 72 applies a compressive force against the target threaded screw receiver 26 itself.

Alternatively, locking female threaded bore 34 is another security nut, such as but not limited to a jam nut or other lock nut.

Threaded nut or other threaded insert of threaded bore 34 is optionally further spaced inwardly away from first exterior surface 36 of body 32. By example and without limitation, threaded insert 34 is further molded into body 32 of security member 30, or received into a seat provided in body 32 and spaced inwardly away from first exterior surface 36.

Key receiver 38 is formed adjacent to second end 40 of body 32 opposite of threaded bore 34 and aligned with threaded bore 34 along axis 16. By example and without limitation, key receiver 38 is further molded into first end 54 of body 32 of security member 30.

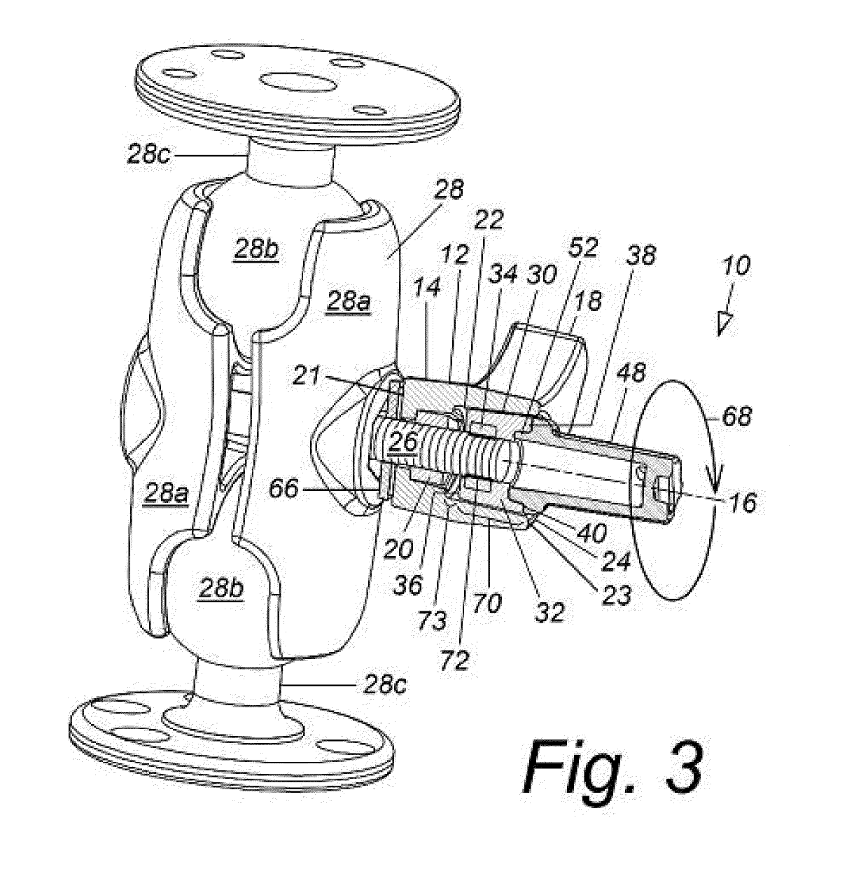

FIG. 3 illustrates threaded security device 10 of FIG. 1 in cross-section. Here, knob 12 is installed onto device 28 by threaded engagement of female threaded bore 20 with male threaded rod or bolt 26. Optionally, a washer 66 may be provided between end surface 21 of knob body 14 and device 28, for example, to ease tightening of knob 12. After threaded knob 12 is installed onto threaded rod or bolt 26 and tightened against device 28, threaded security member 30 is set in body 14 of threaded knob 12 by engagement of threaded bore 34 with threaded rod or bolt 26 of device 28. In operation, security member 30 is turned (arrow 68) onto rod or bolt 26 until body 32 thereof is received completely within bore 22 in body 14 of threaded knob 12. Accordingly, security member 30 is turned 68 until it's second end 40 is received inwardly of opening 23 of bore 22 into second exterior surface 24 of body 14 of threaded knob 12. Accordingly, body 14 of threaded knob 12 substantially screens an entire lengthwise extent 70 of threaded security member 30.

When threaded bore 34 is a locknut or jam nut or other nut, as described herein, that resists loosening under vibrations and torque, a locking interference 72 is formed between female threaded bore 34 and male threaded rod or bolt 26 of device 28. Locking interference 72 is, for example, nylon or other deformable material provided as an insert interior of threaded bore 34, as is generally well-known. Accordingly, security member 30 is not required to be threaded so far into bore 22 of threaded knob 12 as to engage threaded nut or insert 20. Rather, security member 30 may be threaded onto male threads 26 of device 28 only so far that second end 40 of security member 30 is received inwardly of opening 23 of bore 22 into second exterior surface 24 of body 14 of threaded knob 12. Thus, a small space or gap 73 may be provided between end 36 of body 32 and threaded nut or insert 20, but security member 30 is restrained from moving relative to male threads 26 of device 28 by locking interference 72 between female threads 34 and male threads 26. Therefore, lengthwise extent 70 of threaded security member 30 is sized such that body 14 of threaded knob 12 substantially screens entire lengthwise extent 70 even when end 36 of body 32 is spaced away from threaded nut or insert 20 to form gap 73 therebetween.

After threaded security member 30 is set completely within bore 22 in body 14 of threaded knob 12 using key 48, key 48 is removed from engagement with security member 30. Thereafter, security member 30 can only be accessed by insertion of key 48 into key receiver 38. Accordingly, security member 30 can only be removed by application of key 48 having key configuration 52a, 52b, 52c, etcetera through 52xyz formed on key projection 51 and corresponding to the selected key receiver configuration 44a, 44b, 44c, etcetera through 44xyz of threaded security member 30.

When gap 73 is provided between end 36 of body 32 and threaded nut or insert 20, threaded nut or insert 20 can be turned 68 on threaded rod or bolt 26 to loosen or tighten knob 12 relative to device 28 within a range defined by space or gap 73. Accordingly, device 28 can be adjusted without unsecuring or removing threaded security member 30, whereby device 28 remains secure even while it can be adjusted. For example, when device 28 is a ball-and-socket mounts device of the general type disclosed in U.S. Pat. No. 5,845,885, which is incorporated herein by reference, loosening of knob 12 releases the pair of elongated, opposing rigid arm sections 28a in the assembly, which relieves pressure on the compressible part-spherical heads 28b so the pair of couplers 28c can be rotated relative one to the other, whereby device 28 can be adjusted but cannot be disassembled.

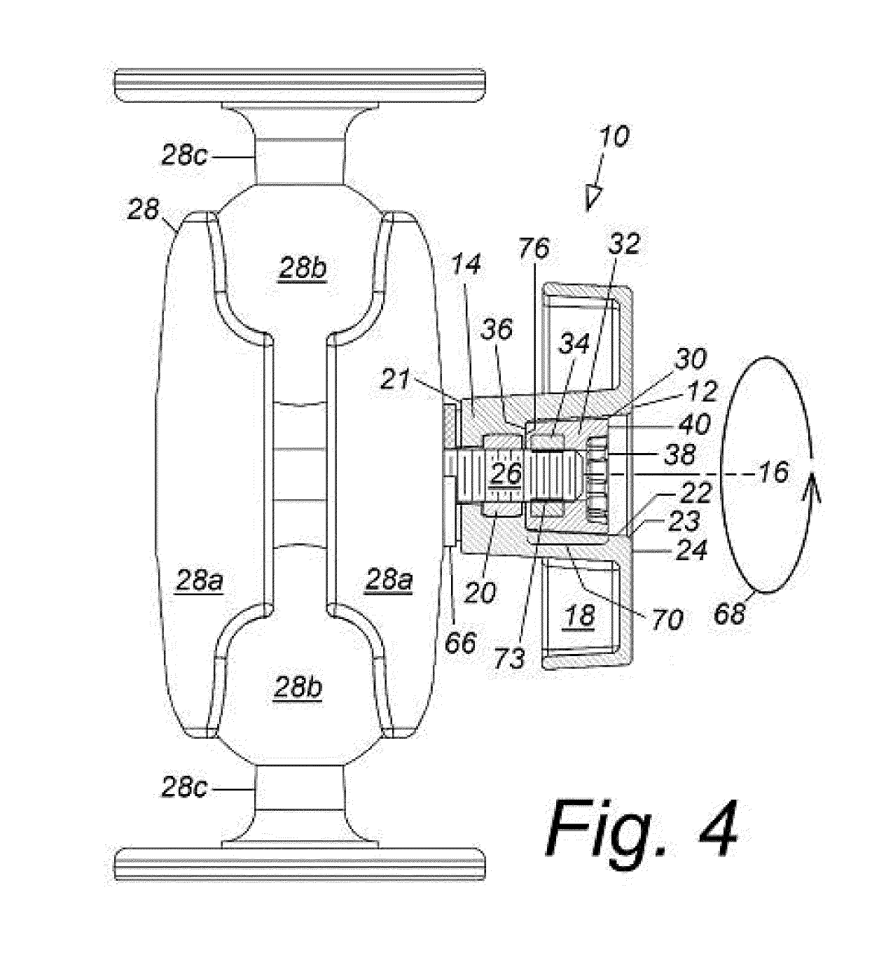

FIG. 4 illustrates threaded security device 10 of FIG. 1 in cross-section. Here, security member 30 is fully seated in body 14 of threaded knob 12 with it's first end 36 against base 76 of bore 22. Accordingly, threaded knob 12 cannot be moved away from device 28 because threaded knob 12 cannot be turned 68 relative to male threads 26. Thus, device 28 cannot be either adjusted or disassembled. Furthermore, entire lengthwise extent 70 of security member 30 is fully screened within bore 22 of body 14 of threaded knob 12 so that security member 30 cannot be dislodged except by application of key 48 with key projection 51 having key configuration 52a, 52b, 52c, etcetera through 52xyz and corresponding to the selected key receiver configuration 44a, 44b, 44c, etcetera through 44xyz of key receiver 38 in threaded security member 30. This illustrates a first nonadjustable secured state of threaded security device 10.

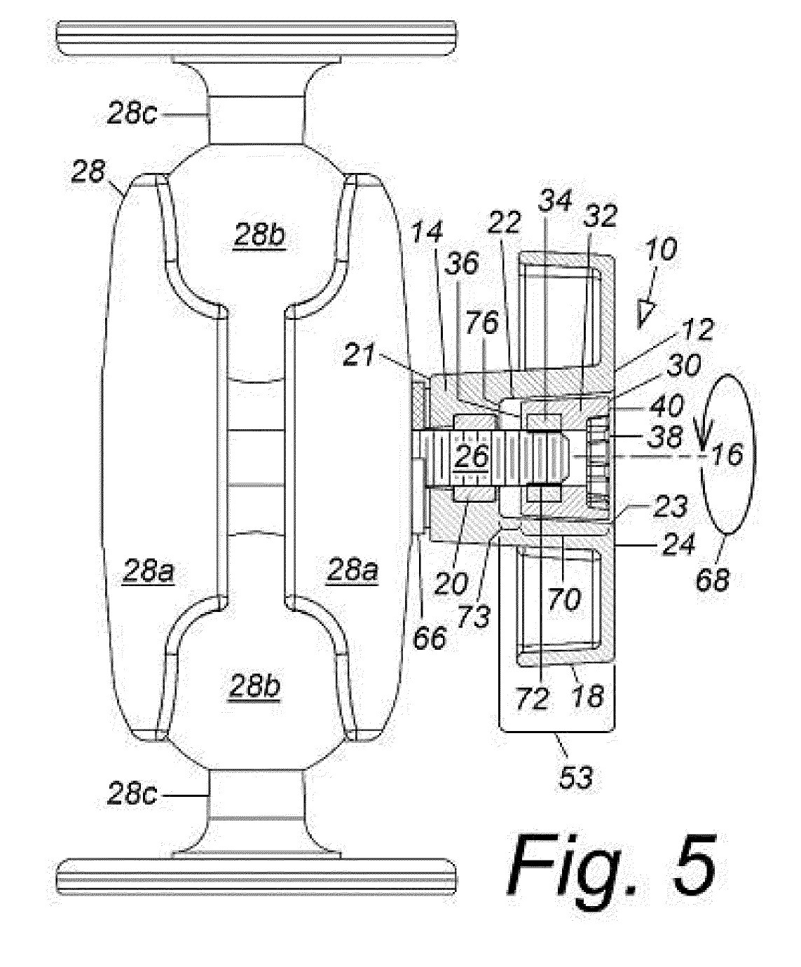

FIG. 5 is a cross-section that illustrates threaded security device 10 of FIG. 1 in a second adjustable secured state of threaded security device 10. Here, similarly to FIG. 3, knob 12 is installed onto device 28 by threaded engagement of female threaded bore 20 with male threaded rod or bolt 26, with optional washer 66 between end surface 21 of knob body 14 and device 28. Threaded security member 30 is set into bore 22 of body 14 of threaded knob 12 by turning 68 of threaded bore 34 onto threaded rod or bolt 26 of device 28.

In operation, security member 30 is received completely within bore 22 in body 14 of threaded knob 12, such that second end 40 of security member 30 is received inwardly of opening 23 of bore 22 in body 14. Accordingly, body 14 of threaded knob 12 substantially screens entire lengthwise extent 70 of threaded security member 30.

Entire lengthwise extent 70 of threaded security member 30 is shorter than bore 22 in body 14 of threaded knob 12 such that an entire overall depth 53 of bore 22 in body 14 is greater than entire lengthwise extent 70 of threaded security member 30. Thus, even when end 36 of body 32 is spaced away from threaded nut or insert 20 at base 76 of bore 22 to form gap 73 therebetween, threaded security member 30 is fully screened within depth 53 of bore 22 in body 14. Therefore, security member 30 may be threaded onto male threads 26 of device 28 only so far that second end 40 of security member 30 is received inwardly of opening 23 of bore 22 into second exterior surface 24 of body 14 of threaded knob 12. Thus, small space or gap 73 may be provided between end 36 of body 32 and threaded nut or insert 20 at base 76 of bore 22.

When threaded bore 34 is a locknut or jam nut or other nut, as disclosed herein, locking interference 72 between female threaded bore 34 and male threaded rod or bolt 26 of device 28 resists turning on threaded rod or bolt 26. In fact, turning of locknut or jam nut 34 on threaded rod or bolt 26 requires application of a lever-arm tool, such as a wrench, as is generally well-known. Accordingly, in this second adjustable secured state of threaded security device 10, security member 30 is not tightened so far into bore 22 of threaded knob 12 as to engage threaded nut or insert 20 at base 76 of bore 22. Rather, locking interference 72 between female threads 34 and male threads 26 restrains security member 30 from moving relative to male threads 26 of device 28 by.

As disclosed herein, after threaded security member 30 is set completely inwardly of opening 23 in body 14 of threaded knob 12 using key 48, key 48 is removed from engagement with key receiver 38. Thereafter, security member 30 can only be loosened by insertion and turning 68 of key 48 in key receiver 38. Accordingly, security member 30 can only be removed by application of key 48 having key configuration 52a, 52b, 52c, etcetera through 52xyz and corresponding to the selected key receiver configuration 44a, 44b, 44c, etcetera through 44xyz of key receiver 38 of threaded security member 30.

When gap 73 is provided between end 36 of body 32 and base 76 of bore 22, threaded nut or insert 20 can be turned 68 on threaded rod or bolt 26 to loosen or tighten knob 12 relative to device 28 within a range defined by space or gap 73. Accordingly, device 28 can be adjusted without unsecuring or removing threaded security member 30, whereby device 28 remains secure even while being adjustable. For example, loosening of knob 12 releases the pair of opposing rigid arm sections 28a of device assembly 28, which relieves pressure on the compressible part-spherical heads 28b so the pair of couplers 28c can be rotated relative one to the other, whereby device 28 can be adjusted but cannot be disassembled.

FIG. 6 is a cross-section that illustrates threaded security device 10 of FIG. 1 operating in the second adjustable secured state of threaded security device 10 when entire overall depth 53 of bore 22 in body 14 is greater than entire lengthwise extent 70 of threaded security member 30. Here, as in FIG. 5, knob 12 is installed onto device 28 by threaded engagement of female threaded bore 20 with male threaded rod or bolt 26, with optional washer 66 between end surface 21 of knob body 14 and device 28. End 36 of body 32 of threaded security member 30 is spaced away from threaded nut or insert 20 at base 76 of bore 22 to form gap 73 therebetween. Threaded knob 12 is then adjustable (arrow 77) along threaded rod or bolt 26 within the range defined by space or gap 73. For example, when threaded knob 12 is withdrawn (arrow 77) on threaded rod or bolt 26 along axis 16 away from forceful contact with device 28 and/or optional washer 66, as shown, a space or gap 80 is developed between end surface 21 of body 14 and device 28 and/or optional washer 66, as shown. Size of space or gap 80 in which threaded knob 12 is movable is determined as a function of the range defined by space or gap 73.

Security device 10 is a security device in contrast to a locking device. In contrast to a locking device, security device 10 does not have any locking feature such as a lock requiring a key or combination for release. Rather, security device 10 operates by screening wall 82 of bore 22 of threaded knob 12 substantially screening the entire lengthwise extent 70 of threaded security member 30 between first end 36 and second end 40 thereof. As disclosed herein, screening the entire lengthwise extent 70 of threaded security member 30 results in the complete shielding of threaded security member 30 from unauthorized manipulation, whereby turning of threaded security member 30 is only possible by application of key 48 into bore 22 through opening 23 in second exterior surface 24 of knob body 14.

Therefore, threaded knob 12 can only be manipulated through key receiver 38 in second end 40 of threaded body 32.

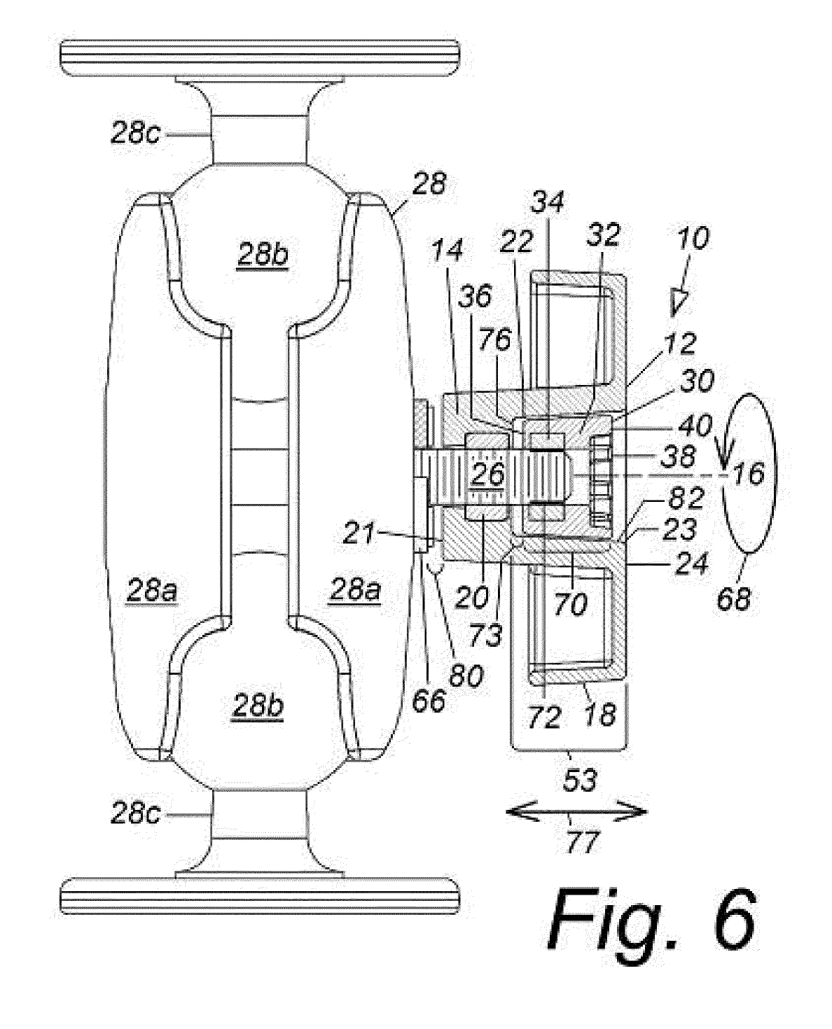

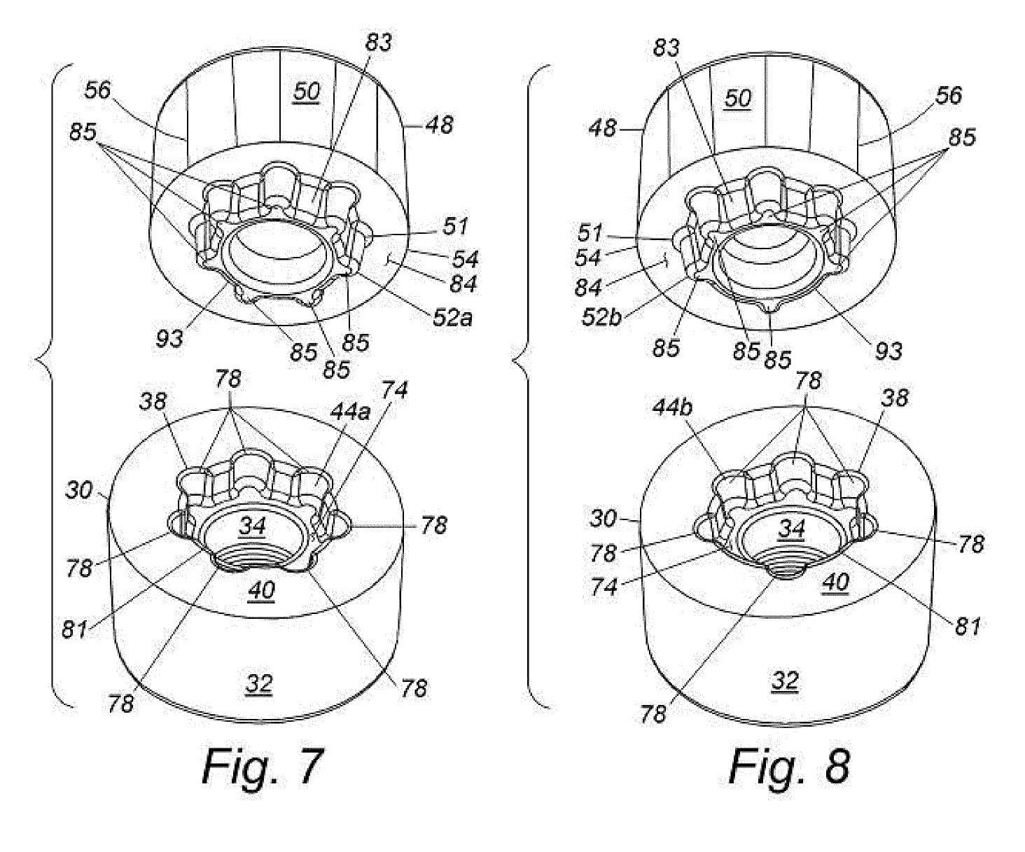

FIG. 7 illustrates threaded security member 30 and corresponding key 48 of security device 10.

Key receiver 38 adjacent to second end 40 of body 32 of threaded security member 30 of each security device 10 is formed having any one of a plurality of different key receiver configurations 44a, 44b, 44c, . . . 44xyz, as discussed herein. All different key receiver configurations 44a, 44b, 44c, . . . 44xyz have in common that none is consistent with a conventional mechanical interface such as, slot or flat drive, Philips, square or Robertson, hex or Allen, Torx, double or triple-square, or other conventional screw drives, including the less common drives generally classified as “tamper-resistant”.

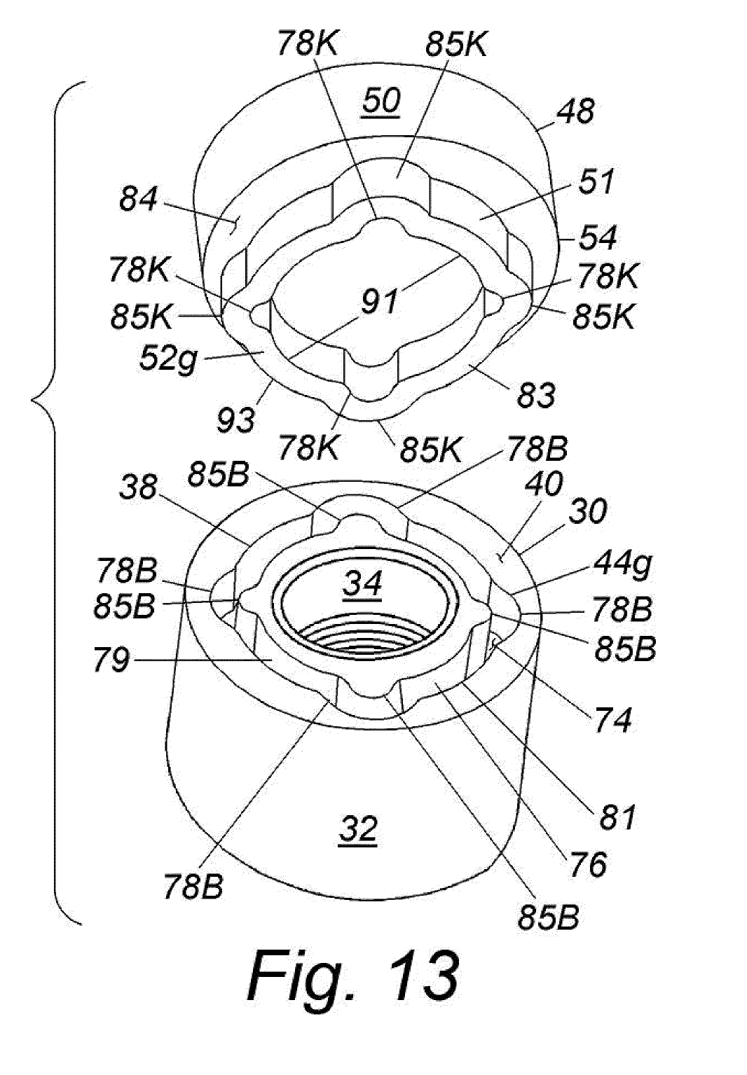

FIG. 7 illustrates key receiver 38 being formed with one key receiver configuration 44a of the plurality of different key receiver configurations 44a, 44b, 44c, . . . 44xyz, formed in second end 40 of security member body 32 opposite of threaded bore 34, wherein key receiver 38 each of security member 30 is formed having one of a plurality of different key receiver configuration 44a, 44b, 44c, . . . 44xyz. By example and without limitation, first key receiver configuration 44a is shown as being a ring-shaped clearance groove 74 recessed into second end 40 of security member body 32 around a central bore containing female threaded bore 34. Any plurality (seven shown) of keyways 78 are branched off from clearance 74. Keyways 78 are either uniformly (shown) or nonuniformly distributed around either inner perimeter 79 (FIGS. 13-15) or outer perimeter 81 of clearance 74.

Operating key 48 is formed with key projection 51 projected from first end 54 of key body 50. Key projection 51 of each key 48 is formed with one of a different key configuration 52a, 52b, 52c, etcetera through 52xyz, with each different key configuration 52a, 52b, 52c, . . . 52xyz being configured to cooperate with a different respective one of different key receiver configurations 44a, 44b, 44c, . . . 44xyz of key receiver 38 of security member 30 of different security devices 10. For example, first key configuration 52a cooperates with first key receiver configuration 44a, second key configuration 52b cooperates with second key receiver configuration 44b, third key configuration 52c cooperates with third key receiver configuration 44c, and this series of combinations of cooperating key configuration 52xyz and key receiver configuration 44xyz continues indefinitely.

Each different key configuration 52a, 52b, 52c, . . . 52xyz of key projection 51 is further configured to be received into respective different cooperating key receiver configurations 44a, 44b, 44c, . . . 44xyz of cooperating key receiver 38 in a mutually relatively nonrotational relationship therewith. Accordingly, each different key configuration 52a, 52b, 52c, . . . 52xyz of key projection 51 engages respective different cooperating key receiver configuration 44a, 44b, 44c, . . . 44xyz of key receiver 38 of different security devices 10 in a mutually rotationally fixed relationship, whereby turning of key 48 causes simultaneous turning of corresponding threaded security member 30, e.g., by operation of either grip 56 or tool seat 58.

Each different key configuration 52a, 52b, 52c, . . . 52xyz of key projection 51 is also structured to be exclusively engageable with a different respective one of different key receiver configurations 44a, 44b, 44c, . . . 44xyz of corresponding key receiver 38.

Furthermore, each different key configuration 52a, 52b, 52c, . . . 52xyz is incompatible with each of the plurality of different key receiver configurations 44b, 44c, 44d . . . 44xyz that are different from the one particular key receiver configuration, e.g., 44a, with which the one particular key configuration, e.g., 52a, is exclusively interchangeable.

Here, for example and without limitation, first key configuration 52a is formed with a ring 83 sized to be received into clearance 74 of cooperating first key receiver configuration 44a in second end 40 of security member body 32. First key configuration 52a is also formed with a plurality (seven shown) of teeth 85 positioned around ring 83 for being received into keyways 78 that are branched off from clearance 74. Teeth 85 are either uniformly (shown) or nonuniformly distributed around either inner perimeter 91 (FIGS. 13-15) or outer perimeter 93 of ring 83 to cooperate with keyways 78.

Key receiver 38 of each security device 10 is formed having any one of a plurality of different key receiver configurations 44a, 44b, 44c, . . . 44xyz, as discussed herein. All different key receiver configurations 44a, 44b, 44c, . . . 44xyz have in common that none is consistent with a conventional mechanical interface such as, slot or flat drive, Philips, square or Robertson, hex or Allen, Torx, double or triple-square, or other conventional screw drives, including the less common drives generally classified as “tamper-resistant”.

FIG. 7 illustrates key receiver 38 being formed with one key receiver configuration 44a of the plurality of different key receiver configurations 44a, 44b, 44c, . . . 44xyz, formed in second end 40 of security member body 32 opposite of threaded bore 34, wherein key receiver 38 each of security member 30 is formed having one of a plurality of different key receiver configuration 44a, 44b, 44c, . . . 44xyz. By example and without limitation, first key receiver configuration 44a is shown as being a ring-shaped clearance groove 74 recessed into second end 40 of security member body 32 around a central bore containing female threaded bore 34. Any plurality (seven shown) of keyways 78 are branched off from clearance 74. Keyways 78 are either uniformly (shown) or nonuniformly distributed around either inner perimeter 79 (FIGS. 13-15) or outer perimeter 81 of clearance 74.

Operating key 48 is formed with key projection 80 projected from first end 54 of key body 50. Key projection 80 of each key 48 is formed with one of a different key configuration 52a, 52b, 52c, etcetera through 52xyz, with each different key configuration 52a, 52b, 52c, . . . 52xyz being configured to cooperate with a different respective one of different key receiver configurations 44a, 44b, 44c, . . . 44xyz of key receiver 38 of security member 30 of different security devices 10. For example, first key configuration 52a cooperates with first key receiver configuration 44a, second key configuration 52b cooperates with second key receiver configuration 44b, third key configuration 52c cooperates with third key receiver configuration 44c, and this series of combinations of cooperating key configuration 52xyz and key receiver configuration 44xyz continues indefinitely.

Each different key configuration 52a, 52b, 52c, . . . 52xyz of key projection 80 is further configured to be received into respective different cooperating key receiver configurations 44a, 44b, 44c, . . . 44xyz of cooperating key receiver 38 in a mutually relatively nonrotational relationship therewith. Accordingly, each different key configuration 52a, 52b, 52c, . . . 52xyz of key projection 80 engages respective different cooperating key receiver configuration 44a, 44b, 44c, . . . 44xyz of key receiver 38 of different security devices 10 in a mutually rotationally fixed relationship, whereby turning of key 48 causes simultaneous turning of corresponding threaded security member 30, e.g., by operation of either grip 56 or tool seat 58.

Each different key configuration 52a, 52b, 52c, . . . 52xyz of key projection 80 is also structured to be exclusively engageable with a different respective one of different key receiver configurations 44a, 44b, 44c, . . . 44xyz of corresponding key receiver 38.

Furthermore, each different key configuration 52a, 52b, 52c, . . . 52xyz is incompatible with each of the plurality of different key receiver configurations 44b, 44c, 44d . . . 44xyz that are different from the one particular key receiver configuration, e.g., 44a, with which the one particular key configuration, e.g., 52a, is exclusively interchangeable.

Here, for example and without limitation, first key configuration 52a is formed with a ring 83 sized to be received into clearance 74 of cooperating first key receiver configuration 44a in second end 40 of security member body 32. First key configuration 52a is also formed with a plurality (seven shown) of teeth 85 positioned around ring 83 for being received into keyways 78 that are branched off from clearance 74. Teeth 85 are either uniformly (shown) or nonuniformly distributed around either inner perimeter 91 (FIGS. 13-15) or outer perimeter 93 of ring 83 to cooperate with keyways 78.

FIG. 7 also illustrates key 48 is optionally formed with a clearance shoulder 84 surrounding and spaced away from key projection 80 for accommodating second end 40 of security member body 32 when engaging with threaded security member 30.

FIG. 8 illustrates threaded security member 30 and corresponding key 48 of security device 10, wherein key receiver 38 of threaded security member 30 is formed having a second key receiver configuration 44b different from first key receiver configuration 44a shown in FIG. 7. Second key receiver configuration 44b is different from all of plurality of different key receiver configurations 44a, 44c, 44d . . . 44xyz, as discussed herein. Here, key projection 80 of key 48 is formed having a second key configuration 52b different from first key configuration 52a shown in FIG. 7. Second key configuration 52b is different from all of plurality of different key configuration 52a, 52c, 52d . . . 52xyz, as discussed herein. Second key configuration 52b is compatible only with key receiver configuration 44b, and is incompatible with each of the plurality of different key receiver configurations 44a, 44c, 44d . . . 44xyz, that are different from the one particular key receiver configuration, e.g., 44b, with which second particular key configuration 52b is exclusively interengageable. In other words, second key configuration 52b is structured to be exclusively engageable with second key receiver configuration 44b.

Here, by example and without limitation, second key receiver configuration 44b is shown as being a ring-shaped clearance groove 74 recessed into second end 40 of security member body 32 around a central bore containing female threaded bore 34. Any plurality (six shown) of keyways 78 are branched off from clearance 74. Keyways 78 are either uniformly or nonuniformly (shown) distributed around either inner perimeter 79 (FIGS. 13-15) or outer perimeter 81 of clearance 74.

Second key configuration 52b is structured to cooperate with second key receiver configuration 44b. For example, second key configuration 52b is formed with ring 83 sized to be received into clearance 74 of cooperating first key receiver configuration 44a in second end 40 of security member body 32. Second key configuration 52b also includes plurality (six shown) of teeth 85 positioned around ring 83 for being received into keyways 78 that are branched off from clearance 74. Teeth 85 are either uniformly or nonuniformly (shown) distributed around either inner perimeter 91 (FIGS. 13-15) or outer perimeter 93 of ring 83 to cooperate with keyways 78.

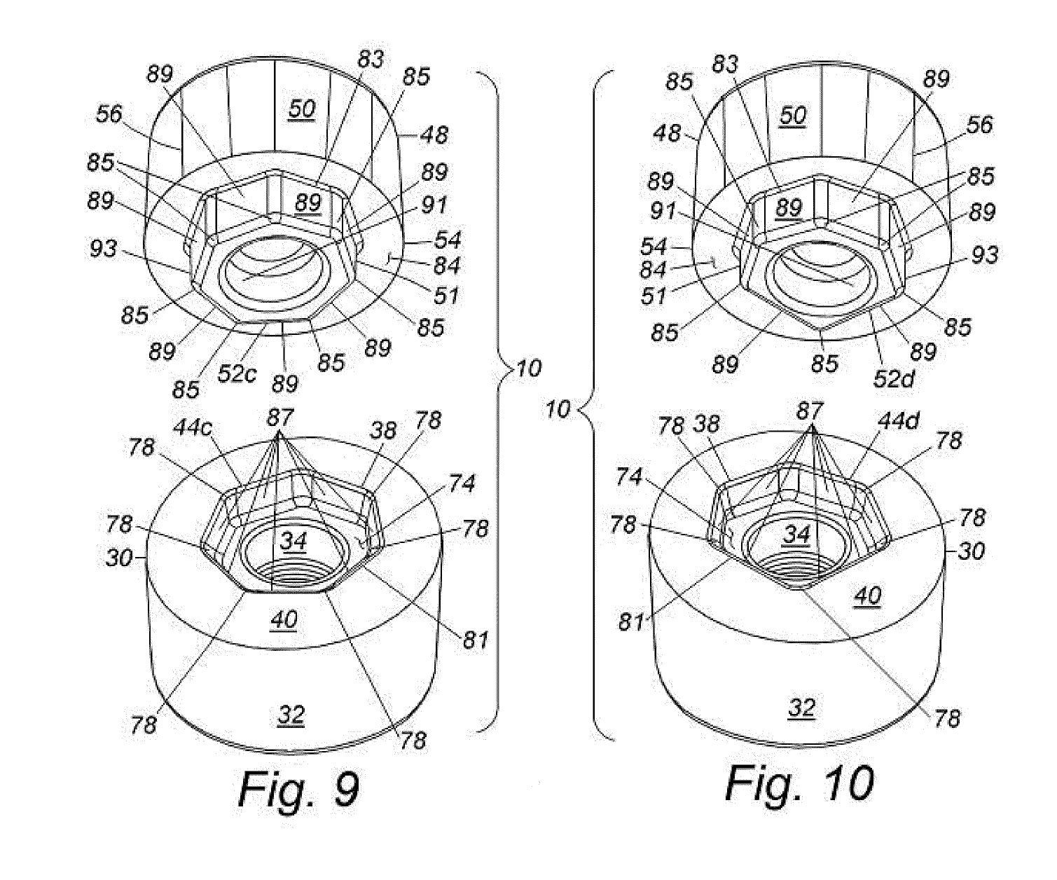

FIG. 9 illustrates threaded security member 30 and corresponding key 48 of security device 10, wherein threaded security member 30 is formed with key receiver 38 adjacent to second end 40 of body 32 and generally aligned along axis 16. Here, key receiver 38 of security member 30 is formed having a third key receiver configuration 44c different from first key receiver configuration 44a shown in FIG. 7, and different from second key receiver configuration 44b shown in FIG. 8. Third key receiver configuration 44c is also different from all of plurality of different key receiver configurations 44a, 44b, . . . 44xyz, as discussed herein. Third key receiver configuration 44c of key receiver 38 operates in combination with cooperating key 48 with key projection 80 having third key configuration 52c.

Third key configuration 52c of key projection 80 of key 48 is different from first key configuration 52a shown in FIG. 7, and different from second key receiver configuration 44b shown in FIG. 8. Third key configuration 52c is different from all of plurality of different key configuration 52a, 52b, 52d, . . . 52xyz, as discussed herein. Third key configuration 52c is compatible only with key receiver configuration 44c, and is incompatible with each of the plurality of different key receiver configurations 44a, 44b, 44d, . . . 44xyz, that are different from the one particular key receiver configuration, e.g., 44c, with which third particular key configuration 52c is exclusively interengageable. In other words, third key configuration 52c is structured to be exclusively engageable with third key receiver configuration 44c.

Here, by example and without limitation, third key receiver configuration 44c is shown with ring-shaped clearance groove 74 recessed into second end 40 of security member body 32 around a central bore containing female threaded bore 34. Any plurality (seven shown) of flats 87 uniformly distributed around outer perimeter 81 of clearance 74. Plurality (seven shown) of intersections of adjacent flats 87 may be considered plurality of keyways 78 that are branched off from clearance 74, and keyways 78 are either uniformly (shown) or nonuniformly distributed around perimeter 81 of clearance 74.

Third key configuration 52c is structured to cooperate with third key receiver configuration 44c. For example, third key configuration 52c is formed with ring 83 sized to be received into clearance 74 of cooperating first key receiver configuration 44a in second end 40 of security member body 32. Third key configuration 52c is also formed with a plurality (seven shown) of flats 89 positioned around ring 83 for being received into operative juxtaposition with flats 87 of clearance 74. Flats 89 of third key configuration 52c are either uniformly (shown) or nonuniformly distributed around outer perimeter 93 of ring 83 to cooperate with flats 87. Plurality (seven shown) of intersections of adjacent flats 89 may be considered plurality of teeth 85 that are positioned around ring 83 for being received into keyways 78 that are branched off from clearance 74 of third key receiver configuration 44c. Teeth 85 are either uniformly (shown) or nonuniformly distributed around either inner or outer perimeter 93 of ring 83 to cooperate with keyways 78.

FIG. 10 illustrates threaded security member 30 and corresponding key 48 of security device 10, wherein threaded security member 30 is formed with key receiver 38 adjacent to second end 40 of security member body 32 and generally aligned along axis 16. Here, key receiver 38 of threaded security member 30 is formed having a fourth key receiver configuration 44d different from all of plurality of different key receiver configurations 44a, 44b, 44c, . . . 44xyz, as discussed herein. Fourth key receiver configuration 44d of key receiver 38 operates in combination with cooperating fourth key configuration 52d of key projection 80 of key 48. Fourth key configuration 52d key projection 80 of key 48 is different from all of plurality of different key configuration 52a, 52b, 52c, . . . 52xyz, as discussed herein. Fourth key configuration 52d is compatible only with fourth key receiver configuration 44d, and is incompatible with each of the plurality of different key receiver configurations 44a, 44b, 44c, . . . 44xyz, that are different from the one particular key receiver configuration, e.g., 44d, with which fourth particular key configuration 52d is exclusively interengageable. In other words, fourth key configuration 52d is structured to be exclusively engageable with fourth key receiver configuration 44d.

Here, by example and without limitation, fourth key receiver configuration 44d is shown as being a ring-shaped clearance groove 74 recessed into second end 40 of security member body 32 around a central bore containing female threaded bore 34. Any plurality (six shown) of flats 87 nonuniformly distributed around outer perimeter 81 of clearance 74. Plurality (six shown) of intersections of adjacent flats 87 may be considered plurality of keyways 78 that are branched off from clearance 74. Keyways 78 are either uniformly or nonuniformly (shown) distributed around either inner perimeter 79 (FIGS. 13-15) or outer perimeter 81 of clearance 74.

Fourth key configuration 52d is structured to cooperate with fourth key receiver configuration 44d. For example, fourth key configuration 52d is formed with ring 83 sized to be received into clearance 74 of cooperating first key receiver configuration 44a in second end 40 of security member body 32. Fourth key configuration 52d is also formed with a plurality (six shown) of flats 89 positioned around ring 83 for being received into operative juxtaposition with flats 87 of clearance 74. Flats 89 of fourth key configuration 52d are either uniformly or nonuniformly (shown) distributed around outer perimeter 93 of ring 83 to cooperate with flats 87. Plurality (six shown) of intersections of adjacent flats 89 may be considered plurality of teeth 85 that are positioned around ring 83 for being received into keyways 78 that are branched off from clearance 74 of third key receiver configuration 44c. Teeth 85 are either uniformly or nonuniformly (shown) distributed around either inner or outer perimeter 93 of ring 83 to cooperate with keyways 78.

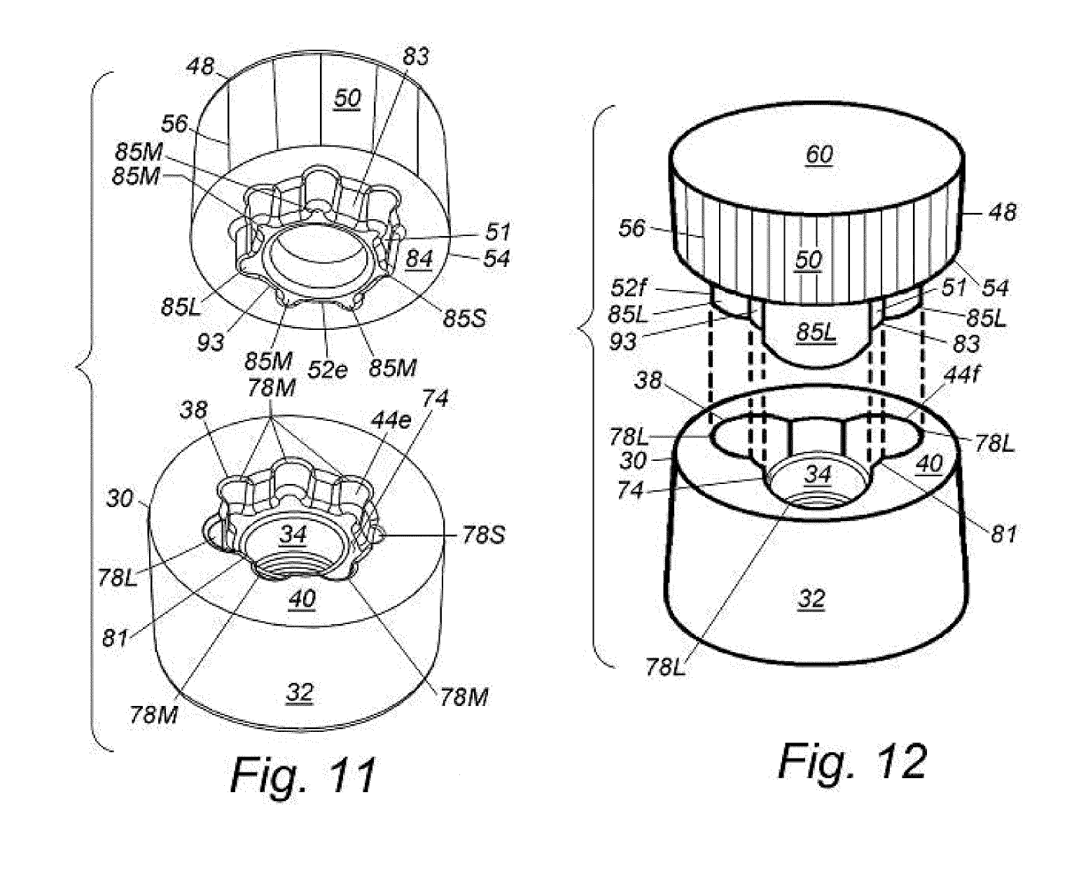

FIG. 11 illustrates threaded security member 30 and corresponding key 48 of security device 10, wherein key receiver 38 of threaded security member 30 is formed having a fifth key receiver configuration 44e different from all of plurality of different key receiver configurations 44a, 44b, 44c, 44d . . . 44xyz, as discussed herein. Fifth key configuration 52e is compatible only with fifth key receiver configuration 44e, and is incompatible with each of the plurality of different key receiver configurations 44a, 44b, 44c, 44d . . . 44xyz, that are different from the one particular key receiver configuration, e.g., 44e, with which fifth particular key configuration 52e is exclusively interengageable. In other words, fifth key configuration 52e is structured to be exclusively engageable with fifth key receiver configuration 44e.

Here, by example and without limitation, fifth key receiver configuration 44e is shown as being a ring-shaped clearance groove 74 recessed into second end 40 of security member body 32 around a central bore containing female threaded bore 34. Any plurality (seven shown) of keyways 78 are branched off from clearance 74. Keyways 78 are either uniformly (shown) or nonuniformly distributed around perimeter 81 of clearance 74. Additionally, here keyways 78 of fifth key receiver configuration 44e are optionally formed of a plurality (three shown) of different sizes, such as but not limited to, large keyways 78L, medium keyways 78M, and small keyways 78S, although more or fewer different sizes of keyways 78 are optionally substituted.

Fifth key configuration 52e is structured to cooperate with fifth key receiver configuration 44e. For example, fifth key configuration 52e is formed with ring 83 sized to be received into clearance 74 of cooperating first key receiver configuration 44a in second end 40 of security member body 32. Fifth key configuration 52e also includes plurality (seven shown) of teeth 85 positioned around ring 83 for being received into keyways 78 that are branched off from clearance 74. Teeth 85 are either uniformly (shown) or nonuniformly distributed around either inner 91 or outer perimeter 93 of ring 83 to cooperate with keyways 78. Furthermore, teeth 85 of fifth key configuration 52e are sized to be received into corresponding keyways 78 of cooperating fifth key receiver configuration 44e. Accordingly, fifth key configuration 52e includes a plurality (three shown) of different size teeth matched to optional different sized keyways 78, when present. For example, fifth key configuration 52e includes one or more large teeth 85L matched to large keyways 78L, one or more medium teeth 85M matched to medium keyways 78M, and one or more small teeth 85S matched to small keyways 78S.

FIG. 12 illustrates threaded security member 30 and corresponding key 48 of security device 10, wherein details of threaded security member 30 and operating key 48 are simplified. Here, key receiver 38 of threaded security member 30 is formed having a sixth key receiver configuration 44f different from all of plurality of different key receiver configurations 44a, 44b, 44c, 44d, 44e, . . . 44xyz, as discussed herein. Sixth key configuration 52f is compatible only with sixth key receiver configuration 44f, and is incompatible with each of the plurality of different key receiver configurations 44a, 44b, 44c, 44d, 44e, . . . 44xyz, that are different from the one particular key receiver configuration, e.g., 44f, with which sixth particular key configuration 52f is exclusively interengageable. In other words, sixth key configuration 52f is structured to be exclusively engageable with sixth key receiver configuration 44f.

Here, by example and without limitation, sixth key receiver configuration 44f is shown with ring-shaped clearance groove 74 recessed into second end 40 of security member body 32 around a central bore containing female threaded bore 34. Any plurality (three shown) of keyways 78 are branched off from clearance 74, and keyways 78 are either uniformly (shown) or nonuniformly distributed around perimeter 81 of clearance 74. Additionally, here keyways 78 of sixth key receiver configuration 44f are optionally all formed as large keyways 78L, although more or fewer different sizes of keyways 78 are optionally substituted.

Sixth key configuration 52f is structured to cooperate with sixth key receiver configuration 44f. For example, sixth key configuration 52f is formed with ring 83 sized to be received into clearance 74 of cooperating first key receiver configuration 44a in second end 40 of security member body 32. Sixth key configuration 52f also includes plurality (three shown) of large teeth 85L positioned around ring 83 for being received into large keyways 78L and are sized to match therewith.

Body 50 of key 48 is optionally formed with a grip mechanism 56, shown as knurling, for gripping key 48 for operation thereof.

FIG. 13 illustrates threaded security member 30 and corresponding key 48 of security device 10, wherein key receiver 38 of threaded security member 30 is formed having a seventh key receiver configuration 44g different from all of plurality of different key receiver configurations 44a, 44b, 44c, 44d, 44e, 44f, . . . 44xyz, as discussed herein. Seventh key configuration 52g is compatible only with seventh key receiver configuration 44g, and is incompatible with each of the plurality of different key receiver configurations 44a, 44b, 44c, 44d, 44e, 44f, . . . 44xyz, that are different from the one particular key receiver configuration, e.g., 44g, with which seventh particular key configuration 52g is exclusively interengageable. In other words, seventh key configuration 52g is structured to be exclusively engageable with seventh key receiver configuration 44g.

Here, by example and without limitation, seventh key receiver configuration 44g is shown as being a ring-shaped clearance groove 74 recessed into second end 40 of security member body 32 around a central bore containing female threaded bore 34. Any plurality (four shown) of keyways 78 and any plurality (four shown) of teeth 85 are branched off from clearance 74 are either uniformly (shown) or nonuniformly distributed around circumference of clearance 74. Additionally, here keyways 78 of seventh key receiver configuration 44f are optionally formed as exterior keyways 78B and in combination with interior teeth 85B. Alternatively, more or fewer different quantities of exterior keyways 78B and interior teeth 85B are optionally substituted. As illustrated, exterior keyways 78B are formed on outer perimeter 81 of clearance 74, and interior teeth 85B are formed on inner perimeter 79 of clearance 74.

Seventh key configuration 52g is structured to cooperate with seventh key receiver configuration 44g. For example, seventh key configuration 52g is formed with ring 83 sized to be received into clearance 74 of cooperating first key receiver configuration 44a in second end 40 of security member body 32. Seventh key configuration 52g also includes both a plurality (four shown) of exterior teeth 85K positioned around outer perimeter 93 of ring 83 and sized for being received into exterior keyways 78B in combination with a plurality (four shown) of interior keyways 78K that are positioned around inner perimeter 91 of ring 83 and sized for receiving thereinto exterior teeth 85B.

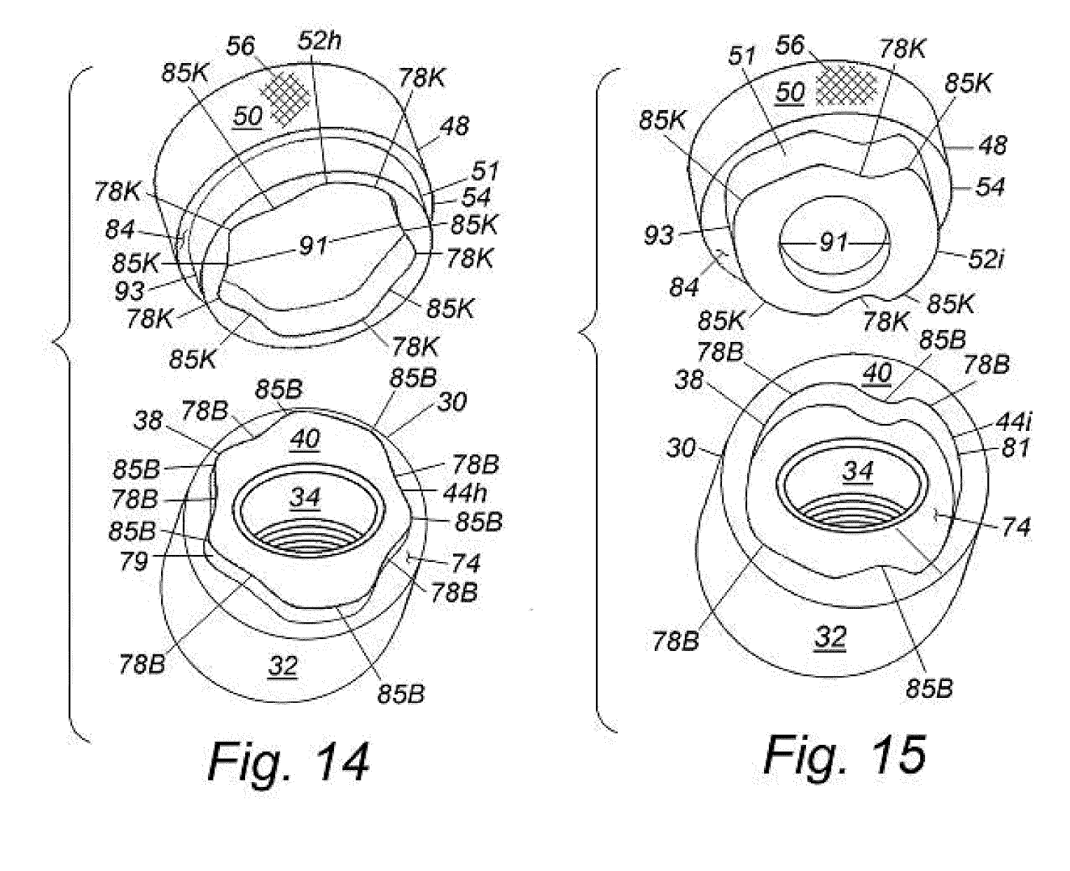

FIG. 14 illustrates threaded security member 30 and corresponding key 48 of security device 10, wherein key receiver 38 of threaded security member 30 is formed having a eighth key receiver configuration 44h different from all of plurality of different key receiver configurations 44a, 44b, 44c, 44d, 44e, 44f, 44g, . . . 44xyz, as discussed herein. Eighth key configuration 52h is compatible only with eighth key receiver configuration 44h, and is incompatible with each of the plurality of different key receiver configurations 44a, 44b, 44c, 44d, 44e, 44f, 44g, . . . 44xyz, that are different from the one particular key receiver configuration, e.g., 44h, with which eighth particular key configuration 52h is exclusively interengageable. In other words, eighth key configuration 52h is structured to be exclusively engageable with eighth key receiver configuration 44h.

Here, by example and without limitation, eighth key receiver configuration 44h is shown as being a ring-shaped clearance groove 74 recessed into second end 40 of security member body 32 around a central bore containing female threaded bore 34 Inner perimeter 79 of clearance 74 includes any freeform shape, as illustrated. By example and without limitation, freeform shape of inner perimeter 79 of clearance 74 is formed with a plurality of interior keyways 78B and interior teeth 85B.

Eighth key configuration 52h is structured to cooperate with eighth key receiver configuration 44h. For example, eighth key configuration 52h is formed with ring 83 sized to be received into clearance 74 of cooperating first key receiver configuration 44a in second end 40 of security member body 32. Eighth key configuration 52h also includes inner perimeter 91 of ring 83 being formed with a freeform shape, as illustrated, matched to freeform shape of inner perimeter 79 of clearance 74. Accordingly, freeform shape of inner perimeter 91 of ring 83 is configured to cooperate with freeform shape of inner perimeter 79 of clearance 74 in a mutually relatively nonrotational relationship therewith. Thus, freeform eighth key configuration 52h of key projection 80 engages corresponding eighth key receiver configuration 44h of key receiver 38 of security member 30 in a mutually rotationally fixed relationship, whereby turning of key 48 causes simultaneous turning of corresponding threaded security member 30, e.g., by operation of key grip mechanism 56.

By example and without limitation, when freeform shape of inner perimeter 79 of clearance 74 is formed with a plurality of interior keyways 78B and interior teeth 85B, freeform shape of inner perimeter 91 of ring 83 is configured coordinating interior keyways 78K and interior teeth 85K sized to received into interior keyways 78B and interior teeth 85B of central hub 76 of body 14 in a mutually relatively nonrotational relationship therewith.

FIG. 15 illustrates threaded security member 30 and corresponding key 48 of security device 10, wherein key receiver 38 of threaded security member 30 is formed having a ninth key receiver configuration 44i different from all of plurality of different key receiver configurations 44a, 44b, 44c, 44d, 44e, 44f, 44g, 44h, . . . 44xyz, as discussed herein. Ninth key configuration 52i is compatible only with ninth key receiver configuration 44i, and is incompatible with each of the plurality of different key receiver configurations 44a, 44b, 44c, 44d, 44e, 44f, 44g, 44h, . . . 44xyz, that are different from the one particular key receiver configuration, e.g., 44i, with which ninth particular key configuration 52i is exclusively interengageable. In other words, ninth key configuration 52i is structured to be exclusively engageable with ninth key receiver configuration 44i.

Here, by example and without limitation, ninth key receiver configuration 44i is shown as being a ring-shaped clearance groove 74 recessed into second end 40 of security member body 32 around a central bore containing female threaded bore 34. Outer perimeter 81 of clearance 74 includes any freeform shape, as illustrated. By example and without limitation, freeform shape of outer perimeter 81 of clearance 74 is formed with a plurality of interior keyways 78B and interior teeth 85B.

Ninth key configuration 52i is structured to cooperate with ninth key receiver configuration 44i. For example, ninth key configuration 52i is formed with ring 83 sized to be received into clearance 74 of cooperating first key receiver configuration 44a in second end 40 of security member body 32. Ninth key configuration 52i also includes outer perimeter 93 of ring 83 being formed with a freeform shape, as illustrated, matched to freeform shape of outer perimeter 81 of clearance 74. Accordingly, freeform shape of outer perimeter 93 of ring 83 is configured to cooperate with freeform shape of outer perimeter 81 of clearance 74 in a mutually relatively nonrotational relationship therewith. Thus, freeform ninth key configuration 52i of key projection 80 engages corresponding ninth key receiver configuration 44i of key receiver 38 of security member 30 in a mutually rotationally fixed relationship, whereby turning of key 48 causes simultaneous turning of corresponding threaded security member 30, e.g., by operation of key grip mechanism 56.

By example and without limitation, when freeform shape of outer perimeter 81 of clearance 74 is formed with a plurality of interior keyways 78B and interior teeth 85B, freeform shape of outer perimeter 93 of ring 83 is configured coordinating interior keyways 78K and interior teeth 85K sized to received into interior keyways 78B and interior teeth 85B of outer perimeter 81 of clearance 74 in a mutually relatively nonrotational relationship therewith.

Additional alternative cooperating embodiments of different key receiver configurations 26j . . . 44xyz of key receiver 38 and key configurations 82j . . . 52xyz of key projection 80 are also contemplated and are within the skill of one of ordinary skill in the art to which the instant invention pertains in light of the instant disclosure and may be substituted without deviating from the scope and intent of the present invention.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1: A threaded security device, comprising:
a knob comprising a body comprising a first exterior surface, a second exterior surface, an interior, a threaded bore extending from the first exterior surface of the body into the interior of the body, and a generally cylindrical bore extending between the threaded bore to the second exterior surface of the body;
a threaded security member comprising a body sized to be received into the cylindrical bore of the knob, the body of the threaded security member comprising a first end, a second end, a threaded bore adjacent to the first end, and a key receiver adjacent to the second end opposite of the threaded bore, wherein the key receiver has a key receiver configuration selected from a plurality of different key receiver configurations; and
a key comprising a key configuration selected from a plurality of different key configurations and corresponding to the key receiver configuration of the threaded security member.

2: The threaded security device of claim 1, wherein the knob substantially screens an entire lengthwise extent of the threaded security member.

3: The threaded security device of claim 2, wherein the entire lengthwise extent of the threaded security member is received into the cylindrical bore of the knob, whereby the knob substantially screens the threaded security member between the first and second ends thereof.

4: The threaded security device of claim 1, wherein the knob further comprises a generally rigid handle extended laterally of the body.

5: The threaded security device of claim 1, wherein the threaded bore of the knob further comprises a threaded insert seated in the interior of the body of the knob.

6: The threaded security device of claim 1, wherein the threaded bore of the knob and the threaded bore of the threaded security member each comprise same thread diameter and pitch.

7: The threaded security device of claim 1, wherein the key receiver is recessed into the second end of the body of the threaded security member.

8: The threaded security device of claim 8, wherein the key receiver of the threaded security member is substantially aligned with the threaded bore thereof.

9: The threaded security device of claim 1, wherein the female threaded bore of the threaded security member comprises a threaded insert seated in the interior of the body.

10: The threaded security device of claim 9, wherein the threaded insert of the threaded security member further comprises a locknut.

11: The threaded security device of claim 10, wherein the threaded insert is further molded into the body of the threaded security member.

12: The threaded security device of claim 1, wherein the key further comprises a tool seat opposite of the key configuration.

13: The threaded security device of claim 1, wherein the key further comprises a grip mechanism formed thereon.

14: A threaded security device, comprising:
a threaded knob comprising a rigid body comprising a first exterior end surface, a second exterior end surface opposing the first exterior end surface, an exterior side surface, an interior between the first exterior end surface and the second exterior end surface, a grip mechanism formed on the exterior side surface of the body between the first and second exterior end surfaces, a threaded bore extending perpendicularly from the first exterior end surface into the interior, and a cylindrical bore that is larger in diameter than the threaded bore and extends between the threaded bore at the interior and the opposing second exterior end surface;
a separate threaded security member cooperating with the threaded knob and comprising a first end, a second end, and a cylindrical body defining a central longitudinal axis between the first and second ends and being sized to be received lengthwise into the larger cylindrical bore of the threaded knob, the body of the threaded security member comprising a threaded bore formed along the central longitudinal axis at the first end, and a key receiver disposed at the second end opposite of the threaded bore, wherein the key receiver has a key receiver configuration selected from a plurality of different key receiver configurations; and
a separate key cooperating with the threaded security member and comprising a key configuration selected from a plurality of different key configurations and corresponding to the key receiver configuration of the threaded member.

15: The threaded security device of claim 14, wherein a depth of the cylindrical bore in the body of the threaded knob is greater than an overall length of the threaded security member.

16: The threaded security device of claim 15, wherein the key receiver is recessed into the second end of the body of the threaded security member.

17: The threaded security device of claim 16, wherein the threaded bore of the threaded security member comprises a threaded insert seated in the interior of the body of the threaded security member adjacent to the first end thereof.

18: The threaded security device of claim 17, wherein the threaded insert of the threaded security member further comprises a locknut.

19: The threaded security device of claim 18, wherein the threaded insert is further molded into the body of the threaded security member.

20: A threaded security device, comprising:
a threaded knob comprising a rigid body defining a central longitudinal axis, the body of the threaded knob comprising a first end surface, a second end surface opposite the first end surface, an opening in the second end surface, a female thread aligned along the central longitudinal axis adjacent to the first end surface of the body, and a cylindrical interior bore aligned along the central longitudinal axis and communicating between the female thread and the opening in the second end surface of the body;
a first threaded security member comprising a cylindrical body defining a central longitudinal axis, the body of the threaded security member being shorter in length along the central longitudinal axis than a depth of the cylindrical interior bore of the threaded knob between the female thread and the opening in the second surface of the body, the body of the threaded security member comprising a first end, a second end, a female thread aligned along the central longitudinal axis adjacent to the first end of the body, and a key receiver disposed adjacent to the second end of the body opposite of the female thread, wherein the key receiver has a key receiver configuration selected from a plurality of different key receiver configurations; and
a first key comprising a key configuration selected from a plurality of different key configurations and corresponding to the key receiver configuration of the threaded security member, wherein each key configuration is exclusively interconnectable with a single one of the plurality of different key receiver configurations.

21: The threaded security device of claim 20, further comprising: a second threaded security member, wherein the key receiver configuration of the first threaded security member is different from the key receiver configuration of the second threaded security member; and
a second key, wherein the key configuration of the first key corresponds to the key receiver configuration of the first threaded security member but does not correspond to the key receiver configuration of the second threaded security member, and the key configuration of a second key corresponds to the key receiver configuration of the second threaded security member but does not correspond to the key receiver configuration of the first threaded security member.
